(19) United States
(12) Patent Application Publication
(10) Pub. No.: US 2017/0061461 A1
(43) Pub. Date: Mar. 2, 2017

(54) SECONDARY DEVICE COMMUNICATIONS FOR INTELLIGENT SELECTION OF ELECTRONIC SOURCES

(71) Applicant: PAYPAL, INC., San Jose, CA (US)

(72) Inventor: Pawankumar Jajara, Milpitas, CA (US)

(21) Appl. No.: 14/836,506

(22) Filed: Aug. 26, 2015

(51) Int. Cl. G06Q 30/02; G06Q 20/36

(52) U.S. Cl. CPC G06Q 30/0222; G06Q 20/367

(57) ABSTRACT

There are provided systems and methods for secondary device communications for intelligent selection of electronic sources. User data for a user may be determined, such as through device location detection, mapping, biometric, or other components. A service provider may use the user data with pre-set preferences for use of payment instruments or other funding sources in a digital wallet for a user. The user may set the preferences based on rewards choices or goals for benefits conveyed by use of the funding sources so that funding sources with preferred benefits are favored. The service provider may determine a funding source to use based on the user data indicating a merchant the user may potentially interact with. A payment mechanism to use the funding source may be communicated to a secondary device of the user for use with the merchant.

### TECHNICAL FIELD

The present application generally relates to user and location data collection to intelligently select an electronic instrument used by a secondary device and more specifically to secondary device communications for intelligent selection of electronic sources.

### BACKGROUND

Various funding sources used by users may convey benefits through use of the funding sources. For example, the funding sources may provide cash-back, airline miles for use in travel, hotel stays, points in a rewards program, or other type of benefit when the funding source is used to pay for a transaction. Additionally, users may enroll in rewards programs that may be utilized with one or more funding sources to further receive benefits, including coupons, discounts, membership levels, or other reward program incentive. However, the user may be unaware of which benefit is best for the user to use for a transaction. For example, one credit card may be limited to benefits on a maximum of $1,500 in purchases annually. Thus, if the user exceeds this amount, the user may use the credit card but not be receiving any benefit. Moreover, the benefits may be merchant or scenario specific, so that the user may not optimize their reward earnings if the user uses the improper funding source during a transaction. While the user may peruse the options available with their funding sources through literature available when the user receives the funding source, this information may not be available to the user during a transaction. Moreover, if the user is using a secondary device, such as a wearable computing device, the user may be limited to basic payment functions.

### BRIEF DESCRIPTION OF THE DRAWINGS

FIG. 1 is a block diagram of a networked system suitable for implementing the processes described herein, according to an embodiment;

FIG. 2 is an exemplary environment where users may receive payment mechanisms to utilize funding sources through a secondary device for preferred rewards benefits, according to an embodiment;

FIG. 3 is an exemplary interaction flowchart and resulting digital wallet having user preferences during establishment of the digital wallet and user preferences for rewards optimization, according to an embodiment;

FIG. 4 is a flowchart of an exemplary process for secondary device communications for intelligent selection of electronic sources, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for secondary device communications for intelligent selection of electronic sources. Systems suitable for practicing methods of the present disclosure are also provided.

A user may utilize a service provider, such as a payment provider, to establish a digital wallet. The digital wallet may correspond to an online account, accessible through a device and storable for use in an offline environment using the device, that stores payment instruments and other funding sources of the user. The user may establish the digital wallet by providing information for funding sources to the service provider, for example, using a communication device (e.g., personal computer, mobile smart phone, tablet computing device, etc.) to transmit data to the service provider over a network. The payment instruments may include credit cards, debit cards, gift cards, banking accounts, coupons, discounts, rewards, cash-back offers, and/or investments and returns from the investments. The payment instruments may further include associated benefits convey through use of the payment instruments, which may also be stored to the digital wallet. Benefits may include rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons. The digital wallet may further include rewards programs enrolled by the user, such as grocery store rewards cards, points earning programs, restaurant membership levels, or other incentives.

The service provider may then establish the digital wallet, which may be used in future transactions to provide payment to an entity (e.g., a merchant or other user) for a transaction. The user may access the digital wallet and select a payment instrument during the transaction. The user's device and/or the service provider may then initiate a payment process with the entity for the transaction, such as through secure tokenized data transmission, which may include information used to process a payment using the selected payment instrument. The digital wallet may also store transaction histories in various embodiments, which may document completed or declined transactions. Additionally, the digital wallet may also include information on each of the payment instruments, such as interest rates for credit cards,

Additionally, the service provider may request for the user to set up a rewards optimizer for use of the benefits for the payment instruments in the digital wallet. If the user wishes to enroll in the rewards optimizer, the user may be requested to provide user preferences for receipt of the benefits through use of the payment instruments. For example, in one embodiment, the user may provide a ranking of most important to least important benefits to the user. Thus, the user may indicate that the user most highly prefers a first benefit, such as highest cash-back. However, the user may prefer points in a rewards program next, and a promotional or actual credit APR percentage the least. In other embodiments, the user may establish goals for benefits, such as hitting 50,000 airline miles or reaching 100,000 rewards program points. Thus, the user may request that the payment instrument providing that benefit is used until a goal is reached. The user may then specify another payment instrument to use after reach that goal. The second payment instrument may also have a goal for benefits earnings, where further payment instruments and goals may be further set by the user.

The user may also set a benefit to maximize, for example, if the benefit has a maximum potential earning in a time frame (e.g., per month, year, lifetime, over a set time period, during certain time periods, etc.). The user may then set which benefit to accrue or maximize next. Moreover, the user may also set which benefits and/or payment instruments should be used for what transactions, which may be based on the benefits accrued from the transaction type. For example, the user may wish to accrue cash-back from gas purchases because the user receives a higher percentage of cash-back from the gas purchases. In further embodiments, the user may also elect to receive a mix of two or more benefits, such as a 70%-30% split between two benefits. In such embodiments, the user may prioritize both rewards equally, but elect to receive a mix so that two or more payment instruments are used for transactions based on the split.

Using the aforementioned input, settings, and/or information available for the user (including transaction history information and benefits rewarding from use of the payment instruments of the user), the service provider may determine the user preferences for the user. The user preferences for benefits associated with one or more payment instruments may also be affected by what is available at merchant locations, and an amount of credit/funding/benefit available at that merchant location. Moreover, the user preferences may change as the user maxes out a receivable benefits and/or based on lower rates of return on benefits as more is accrued, as previously discussed. Thus, the user preferences may not necessarily be static, and a payment instrument may be intelligently selected based on the information the user has entered while establishing the user preferences, the merchant the user wishes to or may transaction with, and/or dynamic based on past spending patterns and/or histories. For example, the user preferences may be used to select a payment instrument that maximizes benefit earnings across all benefit goals based on the user's transaction history.

If the user wishes to enroll in the digital wallet and/or rewards optimizer, the user may also be requested to select a secondary device for use during a transaction. A secondary device may correspond to a device with less computing power and/or features than a communication device. In various embodiments, the secondary device may correspond to a wearable computing device, such as a wearable biometric sensor, smart watch, smart eyeglasses, or other type of wearable device. The identifier may be used to identify the secondary device and determine the capabilities of the secondary device. Additionally, the identifier may be utilized for communication between the service provider and the secondary device, for example, over a network. In other embodiments, the user may provide different information for the secondary device, including device parameters, capabilities, available software, and hardware information. The service provider may utilize the information to determine a mechanism that effectuates payment to a merchant using the selected payment instrument. For example, the mechanism may include a displayable code (e.g., barcode, QR code), a token having payment information (e.g., a redeemable token for a payment using the payment instrument or an encrypted token including the payment instrument details), and/or user information and limited term code (e.g., computer code) allowing a merchant device to contact the service provider to receive a payment from the payment wallet.

Once the settings for the digital wallet and/or the rewards optimizer are set, the settings may be used in future transactions to select a payment instrument to use in a potential transaction with a merchant associated with the user based on the user's current data. For example, the user may be determined to be likely to engage in a transaction with a merchant when the user's current data indicates that the user is at, nearby, or likely to visit the merchant. A user may generate user information/data, for example, through user actions, which may be collected by one or more devices or servers. For example, the user's communication device may receive data corresponding to the user, which may include the user's personal/financial information (including demographic information), location (e.g., through a GPS transceiver or other location determining system), biometrics, communications/messages, and/or other available device actions by the user. The information may also include data entered to the communication device, such as a travel route in a mapping application, search histories in a web browser or merchant application, etc. Additionally, a service provider may collect data associated with the user's online transactions, social networking interactions, messages, connections, loyalty program information, and/or other available online actions by the user.

Using the aforementioned information, a merchant that the user may utilize or transact with may be determined. For example, if the user's location matches the merchant's location, it may be determined that the user may engage in a transaction with that merchant. In other embodiments, if the user has entered a merchant location as a destination to a travel route, the user may be determined to visit that merchant. Where the user's location may match a plurality of merchant locations, the user's past transaction history or other information (e.g., time of day) may be used to determine one or more merchant's the user may visit.

Once the merchant is determined, the service provider may optimize the user's potential rewards earnings using a payment instrument for a transaction between the user and the merchant. In this regard, the service provider may determine what payment instruments the merchant accepts. Using the available payment instruments, the service provider may utilize the user preferences for benefit earnings set with the service provider's rewards optimizer to determine which payment instrument should be used for a transaction to earn the user the benefits the user is most interested in earning out of the available rewards benefits at the merchant location. Thus, if the user prioritizes cash-back, and 2% cash-back is available using payment instrument A, while 3% cash-back is available using payment instrument B, the service provider may determine that payment instrument B. In similar fashion, if the user prioritizes cash-back over airline miles, and payment instrument C offers airline miles, the service provider may still select payment instrument B for the transaction as the user prefers to earn cash-back benefits. However, if no payment instrument having cash-back is available at the merchant location (e.g., the merchant location does not accept either payment instrument A or B), the service provider may determine the next highest ranked or prioritized benefit. Thus, the service provider would use payment instrument C to receive airlines miles over another payment instrument providing a lower prioritized benefit or no benefit. Moreover, the service provider may analyze available funds, credit limits, interest rates, and/or minimum/maximum funds thresholds to further determine the payment instrument.

The service provider may utilize multiple payment instruments where multiple benefits are determined using the user preferences. Moreover, the service provider may select a lower prioritized payment instrument where the user may receive better benefits and/or benefit amounts. Thus, the service provider may select the payment instrument using the benefits earned from use of the available payment instruments at the merchant location, an amount, level, percentage, or other quantifier for the benefits that may be earned at that location. For example, certain credit cards may offer 1% cash-back at general merchant locations, but 2% at gas stations, and 3% at grocery stores. Preferences for the previous examples may be set by the user or may be based on intelligent decision making by the service provider. Therefore, if the service provider receives information indicating that the user is likely to reach their goal or maximum available earnings for the higher prioritized benefit without a transaction at the current merchant location, the service provider may select another payment instrument earning a lower prioritized benefit in order to accrue earnings in the lower prioritized benefit while still meeting the required amount for the higher prioritized benefit in other transactions.

Once the payment instrument is selected, the secondary device capabilities may be used to determine the mechanism used to provide a payment to the merchant. The mechanism may include displayable codes on a screen of the secondary device and/or a token or other code package that allows for information to be communicated from the secondary device to a merchant device for the merchant, for example, over short range wireless communications (e.g., near field communications, Bluetooth, Bluetooth Low Energy, WiFi, magnetic, radio, infrared, or other short range wireless communication technology). The payment mechanism may be for a certain amount using the payment instrument. However, where the transaction details are either ambiguous or unknown (e.g., could be an unknown amount), the service provider may allow for a transaction limit, or may authorize any transaction using the payment instrument when the payment mechanism is processed by the service provider to provide payment to the merchant. The user may utilize the secondary device to provide the payment mechanism to a merchant device for the merchant. However, in other embodiments, the user may use the secondary device to receive merchant and/or transaction information, and may transmit the information received by the secondary device with the payment mechanism to the service provider for processing the transaction.

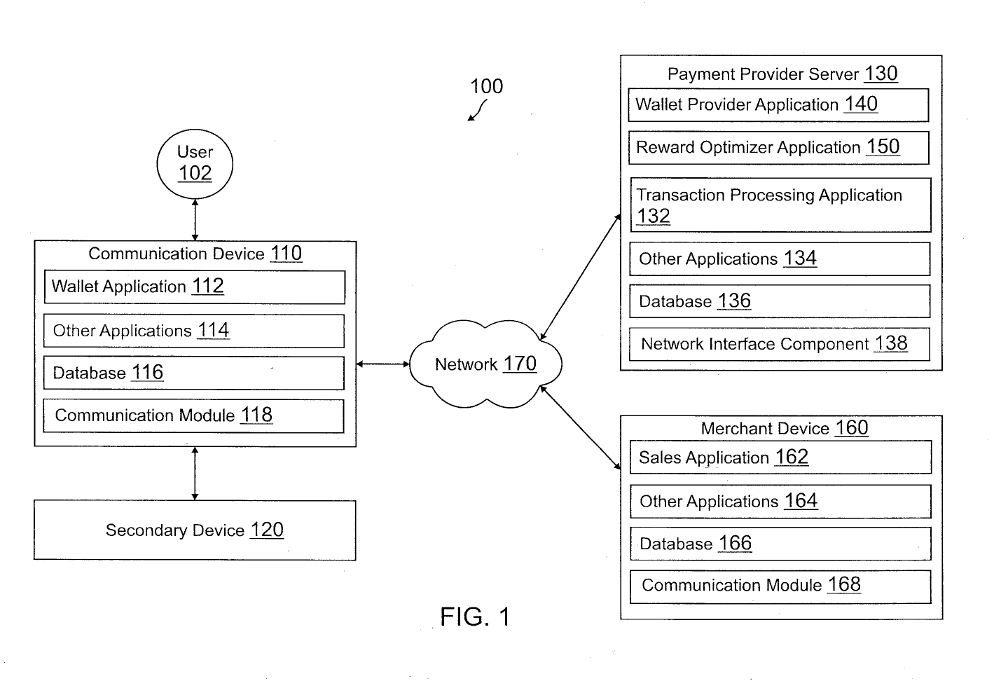

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, a secondary device 120, a payment provider server 130, and a merchant device 160 in communication over a network 170. User 102 may utilize communication device 110 to utilize the various features available for communication device 110, which may include processes and/or applications associated with a digital wallet. In this regard, the digital wallet may be serviced by a service provider server, such as payment provider server 130. The digital wallet may include payment instruments and other funding sources used by the user, which may have benefits associated with the funding sources that are received from use of the funding sources in a transaction. User 102 may further set user preferences for receipt of the benefits associated with funding sources. Payment provider server 130 may therefore be used to determine a payment instrument to use based on user 102's detected information matching a merchant associated with merchant device 160. Payment provider server 130 may further determine a mechanism to effectuate payment to merchant device 160 through secondary device 120 using the payment instrument.

Communication device 110, secondary device 120, payment provider server 130, and merchant device 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented as a communication device that may utilize appropriate hardware and software configured for wired and/or wireless communication with secondary device 120, payment provider server 130, and/or merchant device 160. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains a wallet application 112, other applications 114, a database 116, and a communication module 118. Wallet application 112, other applications 114, and other applications 114 may correspond to executable processes, procedures, and/or applications with associated hardware. In other embodiments, communication device 110 may include additional or different modules having specialized hardware and/or software as required.

Wallet application 112 may correspond to one or more processes to execute modules and associated devices of communication device 110 to enter one or more payment instruments or other funding sources for storage in a digital wallet (e.g., stored and/or serviced by payment provider server 130) and access the digital wallet for use. In this regard, wallet application 112 may correspond to specialized hardware and/or software utilized by communication device 110 to provide an interface to permit user 102 to enter input and other data for payment instruments, for example, through an input device (e.g., touch screen with a graphical user interface displayed by wallet application 112, keypad/keyboard, mouse, etc.) and/or through a data capture device (e.g., scanner, camera, other optical device, etc.) In various embodiments, information for the digital wallet may also be stored to communication device 110 for use in an offline environment. The digital wallet accessible through wallet application 112 may be used to initiate, receive, and/or process/complete transactions using services provided by payment provider server 130. Once entered, the payment instruments may be communicated to payment provider server 130 over network 170 by wallet application 112 for establishment of the digital wallet and/or entry into an existing digital wallet. Moreover, user 102 may further enter data for benefits conferred to user 102 through the use of each of the payment instruments. However, in other embodiments, wallet application 112 and/or payment provider server 130 may retrieve the benefits from one or more third party entities after knowledge of the payment instruments and/or the payment instrument terms. The benefits may correspond to one or more of rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons.

User 102 may further use wallet application 112 to enter preferences for receipt of the benefits conferred from use of the payment instruments. Input used to determine the preferences may be entered at the time of establishment of the digital wallet, after establishment of the digital wallet, and/or on addition of a new funding source to the digital wallet. Thus, if user 102 utilizes a rewards optimizer for benefits offered by payment provider server 130, user 102 may information for receipt of the benefits through use of the payment instruments. Various types of user input that may be used to determine user preferences for receipt of benefits may include rankings of benefits, for example, on a numeric scale or comparative to other benefits (e.g., most to least important). Thus, user 102 may prefer a promotional credit rate over airline miles. User 102 may further prefer cash-back over the promotional credit rate. Thus, user 102 may most highly prefer the cash-back benefits and least prefer the airline miles.

User 102 may set goals for benefits, which may include an amount of the benefits to receive, an amount of time to receive the benefits (e.g., over the next 3 months), and/or a usage rate of the payment instrument for the benefits (e.g., use payment instruments for cash-back for 80% of transactions. User 102 may require the goal to be enforced, and may set further goals. Thus, if one goal is met, the next goal may dictate the next benefit user 102 would like to receive. In other embodiments, once a goal is met, user 102 may instead specify a different payment instrument to use instead of a type of benefit to receive. User 102 may request that the benefit is maximized based on a time frame and/or spending amount or type (e.g., per month, year, lifetime, over a set time period, during certain time periods, or for $1,000, for all gasoline purchase, with a certain merchant or merchant type). User 102 may then set which benefit to accrue or maximize next. In various embodiments, instead of selecting the benefit to receive, user 102 may instead select the payment instrument or type of payment instrument to use for certain transactions, for example, based on the payment instruments potential benefits. User 102 may also provide percentage usage rates and/or weighted amounts of payment instruments or for receipt of benefits. Thus, if user 102 prefers a 50%-50% split between two benefit types, user 102 may set the split through wallet application 112.

User 102 may further provider loyalty reward programs to use with payment instruments for certain transaction, and may set the preferences for which loyalty rewards programs to use for transactions in a similar manner as described above. User 102 may further set information on usage when a payment instrument or preferred benefit is maxed out so that either the payment instrument no longer can be user or user 102 will no longer receive further benefits. Additionally, wallet application 112 may further request information for secondary device 120, which may include an identifier for secondary device 120 and/or device information for secondary device 120. The information may be used to determine a payment mechanism usable by secondary device 120 with merchant device 160, as discussed herein.

Wallet application 112 may be implemented as a user interface enabling user 102 to select and provide payment options on checkout/payment of one or more items with a merchant, and complete a transaction for the item(s) through a purchase request for the item(s). In various embodiments, wallet application 112 may include a general browser application configured to retrieve, present, and communicate information over the Internet (e.g., utilize resources on the World Wide Web) or a private network. For example, wallet application 112 may provide a web browser, which may send and receive information over network 170, including retrieving website information, presenting the website information to user 102, and/or communicating information to the website, including payment information. However, in other embodiments, wallet application 112 may include a dedicated application of payment provider server 130 or other entity (e.g., a merchant), which may be configured to assist in processing purchase requests. Moreover, in other embodiments, payment provider server 130 may not perform transaction processing, and may instead correspond to another service provider, where wallet application 112 may include processes to access and utilize services provided by such a service provider, for example, the one or more of processes described herein.

Wallet application 112 may be utilized to select payment instrument(s) for use during a transaction between user 102 and the merchant associated with merchant device 160. For example, user 102 may wish to complete a transaction with a merchant to purchase the item. Wallet application 112 may utilize user financial information, such as a credit card, bank account, or other financial account, as a payment instrument when providing payment information for use in the authentication mechanism. Additionally, wallet application 112 may utilize a user account with payment provider, such as payment provider server 130, as the payment instrument. User 102 may therefore cause a transaction to be generated that includes a payment request to the merchant for one or more items for purchase. The transaction may be communicated to payment provider server 130 for processing. Wallet application 112 may be utilized to view the results of the transaction and/or for viewing and storage of a transaction history, such as a receipt. In various embodiments, the aforementioned transaction processing may correspond to a user action, where the details of the user action (e.g., the transaction history) are stored and/or communicated to payment provider server 130 for processing with a dynamic user profile. The user actions may be included in user data processed by payment provider server 130.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications. Other applications 114 may also include other location detection applications, which may be used to determine a location for user 102, such as a mapping, compass, and/or GPS application, which can include a specialized GPS receiver that obtains location information for communication device 110 and processes the location information to determine a location communication device 110 and user 102. Other applications may include social networking applications, media viewing, and/or merchant applications. Other applications 114 may also be associated with other devices, such as biometric devices and other types of accessible or connected devices. Other applications 114 may be utilized by other applications 114 to determine user data or other information, which may be communicated to payment provider server 130. Other applications 114 may include device interfaces and other display modules that may receive input from user 102 and/or output information to user 102. For example, other applications 114 may contain software programs, executable by a processor, including a graphical user interface (GUI) configured to provide an interface to the user.

Other applications 114 may collect, capture, and/or otherwise determine user data and other information for user 102, which may be used to determine a merchant associated with user 102 for a potential transaction. User 102's information may correspond to locations of user 102, which may further be determined using a location determination system, such as a GPS module of communication device 110 and associated systems. In other embodiments, user 102's actions may correspond to biometrics, which may be input by user 102 and/or captured with the assistance of a connected device, such as a pedometer (e.g., a FITBIT® or similar device using a short range wireless communication with communication device 110). In various embodiments, other applications 114 may determine messaging information, browsing/search histories, travel routes, destinations, calendars, and other online and offline interactions through messaging applications (e.g., email, SMS/MMS, instant messaging, and/or social networking messaging), Internet browsers, Internet search engines, social networking applications, merchant and shopping applications, travel applications (e.g., travel fare reservation and purchasing applications including air travel, as well as local travel applications for utilizing subways, taxis, car rentals, and other transportation local to user 102), and/or mapping applications.

In various embodiments, one or more of the discussed hardware and/or software features of wallet application 112 and other applications 114 may be included in the same application and/or feature.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with wallet application 112 and/or other applications 114, identifiers associated with hardware of communication device 110, or other appropriate identifiers, such as identifiers used for payment/user/device authentication or identification, which may be communicated as identifying user 102/communication device 110 to payment provider server 130 and/or merchant device 160. Database 116 may include a digital wallet and associated information used by wallet application 112, as well as data determined using other applications 114, such as user information communicated to payment provider server 130.

Communication device 110 includes at least one communication module 118 adapted to communicate with secondary device 120, payment provider server 130 and/or merchant device 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Secondary device 120 may correspond to a device associated with user 102, which may utilize appropriate hardware and software configured for wired and/or wireless communication with at least one of communication device 110, payment provider server 130, and/or merchant device 160. For example, secondary device 120 may be communicatively coupled to communication device 110. Secondary device 120 may include short range wireless communication components, which may utilize short range wireless communications to communication with communication device 110 (e.g., over Bluetooth Low Energy, LTE Direct, WiFi, radio frequency, infrared, Bluetooth, near field communications, etc.). In other embodiments, secondary device 120 may further include network communications and be capable of transmitting and/or receiving information from payment provider server 130. Secondary device 120 may also use the communication components to communicate with merchant device 160. Secondary device 120 may include display devices, including GUI's capable of displaying information to users. Secondary device 120 may also include other output devices, including speakers. Secondary device 120 may include input devices, including touch screens. Secondary device may be used to receive a mechanism used to provide payment through a selected payment instrument by payment provider server 130. The mechanism may be configured to process a payment using secondary device 120 and merchant device 160 based on the device capabilities of secondary device 120. In various embodiments, secondary device 120 may correspond to a wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as a FITBIT®. secondary device 120 may include a sensor or other component used to collect the current information associated with user 102, such as an input device, a camera, a microphone, an accelerometer, a motion detector, an environmental sensor, and/or a biometric sensor.

Payment provider server 130 may be maintained, for example, by an online payment service provider, which may provide payment services and/or processing for financial transactions on behalf of users. In this regard, payment provider server 130 includes one or more processing applications which may be configured to interact with communication device 110, merchant device 160, and/or another device/server to facilitate payment for a transaction, including establishment of digital wallets and reward optimization programs for benefits offered through use of payment instruments associated with the digital wallets. In one example, payment provider server 130 may be provided by PAYPAL®, Inc. of San Jose, Calif., USA. However, in other embodiments, payment provider server 130 may be maintained by or include a credit provider, financial services provider, financial data provider, and/or other service provider, which may provide payment services to user 102.

Payment provider server 130 of FIG. 1 includes a wallet provider application 140, a reward optimizer application 150, a transaction processing application 132, other applications 134, a database 136, and a network interface component 148. Reward optimizer application 150, transaction processing application 132, and other applications 134 may correspond to executable processes, procedures, and/or applications with associated hardware. In other embodiments, payment provider server 130 may include additional or different modules having specialized hardware and/or software as required.

Wallet provider application 140 may correspond to one or more processes to execute modules and associated specialized hardware of payment provider server 130 to establish, maintain, and provide a digital wallet to user 102 based on entered payment instruments or other funding sources by user 102. In this regard, wallet provider application 140 may correspond to specialized hardware and/or software to receive information requesting establishment of the digital wallet. The information may include user personal and/or financial information. Additionally the information may include a login, account name, password, PIN, or other account creation information. User 102 may provide a name, address, social security number, or other personal information necessary to establish the digital wallet and/or effectuate payments through the digital wallet, for example, using the payment instruments in the digital wallet. User 102 may also provide information for the payment instruments, for example, through one or more input devices of communication device 110. Once entered, the digital wallet may be established. Wallet provider application 140 may further allow user 102 to service and maintain the digital wallet, for example, by adding and remove payment instruments. The funding instruments may include credit cards, debit cards, bank accounts, funds in a brokerage account, electronic payment accounts, merchant credit accounts, gift cards, coupon codes, discount codes, rewards accounts, and available cash-back from at least one rewards account. Additionally, wallet provider application 140 may provide the digital wallet to user 102 for use through communication device 110. Thus, wallet provider application 140 may be used with transaction processing application 132 to process transactions using the payment instruments. The wallet provider application 140 may further be used to determine mechanisms used to provide payment using each of the payment instruments, for example, based on the device capabilities of secondary device 120.

Reward optimizer application 150 may correspond to one or more processes to execute modules and associated specialized hardware of payment provider server 130 to determine user preferences regarding prioritization of earning benefits received from use of a payment instrument and further determine a payment instrument to use in an upcoming potential transaction between a merchant matching user 102's current information and user 102 based on the user preferences. In this regard, reward optimizer application 150 may correspond to specialized hardware and/or software to first establish user preferences that govern use of payment instruments for transactions based on the benefits each of the payment instruments provide for use in a transaction. In order to establish the user preferences, reward optimizer application 150 may request user 102 to enroll in a program to optimize user 102's benefits earnings. If user 102 chooses to enroll in the program, wallet application 112 of communication device 110 may request input from user 102 used to determine the user preferences, as previously discussed. For example, user 102 may enter rankings, prioritizations, goals, or other selections related to receipt of the benefits. Reward optimizer application 150 may determine the user preferences using this received information as well as information about the benefits, such as terms of receipt of the benefits. Thus, using the aforementioned input, settings, and/or information available for user 102 and the payment instruments, reward optimizer application 150 may determine the user preferences for user 102 and store the user preferences to database 136. The user preferences may include information used to determine when a goal for reward earning is met, when a reward will earn less rewards, currently accrued rewards, rewards available at certain merchants, and/or payment instruments/rewards preferred from certain merchants. The user preferences may also include a transaction history, which may be used to determine where user 102 shops, how much user 102 spends, and the funding limits of the payment instruments and other funding sources.

Reward optimizer application 150 may further request information identifying secondary device 120, including an identifier and/or device capabilities. In various embodiments, a model number and/or brand information may be entered allowing reward optimizer application 150 to determine information about secondary device 120 and the hardware and/or software of secondary device 120. The identifier for secondary device 120 may be used by reward optimizer application 150 to provide identification in a tokenized payment process, and/or may be used to communicate with secondary device 120. Additionally, the device capabilities may be used to determine the mechanism selected by wallet application 112 and/or wallet provider application 140 to provide payment through secondary device 120 using a payment instrument selected for a potential transaction with the merchant associated with merchant device 160.

Reward optimizer application 150 may further receive, access, and/or determine user information for user 102. The user information may include personal/financial information (including demographic information), location (e.g., through a GPS transceiver or other location determining system), biometrics, communications/messages, and/or other available device actions by the user. The information may also include data entered to the communication device, such as a travel route in a mapping application, search histories in a web browser or merchant application, etc., for user 102.

Once the settings for the digital wallet and/or the rewards optimizer are set, the settings may be used in future transactions to select a payment instrument to use in a potential transaction with a merchant associated with the user based on the user's current data. For example, the user may be determined to be likely to engage in a transaction with a merchant when the user's current data indicates that the user is at, nearby, or likely to visit the merchant. A user may generate user information/data, for example, through user actions, which may be collected by one or more devices or servers. Additionally, reward optimizer application 150 may collect data associated with the user's online transactions, social networking interactions, messages, connections, loyalty program information, and/or other available online actions by the user. Reward optimizer application 150 may determine that user 102 may or is likely to interact with the merchant associated with merchant device 160 based on the user information. For example, user 102 may be located at or near a merchant location for the merchant, or may have entered the merchant location as a destination in a travel route. In other embodiments, additional or different factors may be used, such as demographic information, past transactions, a digital calendar or shopping list, etc.

Reward optimizer application 150 may then select a payment instrument for use in a potential transaction between user 102 and the merchant associated with merchant device 160 using the user preferences for receipt of benefits and the determination that user 102 is likely to interact with the merchant. Reward optimizer application 150 may determine the payment instrument in order to optimize user 102's benefits earnings based on the user preferences. Thus, reward optimizer application 150 may select the payment instrument offer the most benefits for the highest rated benefit. If that payment instrument cannot be used with the merchant, reward optimizer application 150 may select a lower ranked payment instrument based on less benefits or less preferable funding options (e.g., higher APR, less available funds, etc.), or may select a payment instrument offering the next highest rated benefit. Moreover, reward optimizer application 150 may also select the payment instrument based on goals set by the user, and whether the goals have been met, exceeded, or are likely to be exceeded based on future required transactions. Rewards optimizer application 150 may further select the payment instrument based on the terms of the payment instrument and any financial requirements set by user 102 (e.g., maintain a certain balance, do not exceed a certain amount of credit, etc.).

Once reward optimizer application 150 has selected the payment instrument, wallet application 112 and/or wallet provider application 140 may determine a payment mechanism to effectuate payment using the payment instrument through secondary device 120. Additionally, reward optimizer application 150 and/or transaction processing application 132 may determine the limits of the payment mechanism. For example, the payment mechanism may be for a specific amount if details for the transaction are known or can be assumed. However, in other embodiments, reward optimizer application 150 and/or transaction processing application 132 may limit the payment mechanism to the merchant and/or merchant location detected, by an amount of time, and/or by location. In such embodiments, the payment mechanism may only be used for a transaction meeting the aforementioned limiting parameters.

Transaction processing application 132 may further process a received transaction from merchant device 160 by receiving the transaction having a payment request for a payment for the transaction with the payment mechanism used with secondary device 120 for the selected payment instrument by reward optimizer application 150. Thus, transaction processing application 132 may correspond to one or more processes to execute modules and associated specialized hardware of payment provider server 130 to perform transaction processing of a transaction between user 102 and the merchant corresponding to merchant device 160. In this regard, transaction processing application 132 may correspond to specialized hardware and/or software to process a payment request, which may include the mechanism for the selected payment instrument and identification of the transaction, which may be encrypted prior to transmission to transaction processing application 132 to prevent unauthorized receipt of a payment instrument. As discussed herein, secondary device 120 may communicate the mechanism to the merchant using merchant device 160 (e.g., through a scan of a barcode, receipt of a digital payment token through short range wireless communications, etc.). The payment request may include information corresponding to user/merchant identifiers, transaction information and/or other information. Additionally, the transaction may include a payment amount and terms of payment for the transaction. Once the transaction is received and user 102 is authenticated through the mechanism, transaction processing application 132 may utilize the selected payment instrument for user 102 to render payment for the transaction if the mechanism matches the required authentication. Payment may be made to merchant device 160 or another account using the payment instrument and the terms of the payment request, or may be made to a payment account with payment provider server 130 for the merchant associated with merchant device 160. Additionally, transaction processing application 132 may provide transaction histories, including receipts, to communication device 110 and/or merchant device 160, or may store the transaction histories to the user 102's account and/or the merchant's account.

In various embodiments, payment provider server 130 includes other applications 134 as may be desired in particular embodiments to provide features to payment provider server 134. For example, other applications 134 may include security applications for implementing server-side security features, programmatic client applications for interfacing with appropriate application programming interfaces (APIs) over network 170, or other types of applications. Other applications 134 may contain software programs, executable by a processor, including a graphical user interface (GUI), configured to provide an interface to user 102 when accessing payment provider server 134, where user 102 or other users may interact with the GUI to more easily view and communicate information. In various embodiments, other applications 134 may include connection and/or communication applications, which may be utilized to communicate information to over network 170.

Additionally, payment provider server 130 includes database 136. As previously discussed, user 102 and/or the merchant corresponding to merchant device 160 may establish one or more digital wallets and/or payment accounts with payment provider server 130. Digital wallets and/or payment accounts in database 136 may include user/merchant information, such as name, address, birthdate, payment instruments/funding sources, additional user financial information, user preferences, and/or other desired user data. User 102 and/or the merchant may link to their respective digital wallets and/or payment accounts through an account, user, merchant, and/or device identifier. Thus, when an identifier is transmitted to payment provider server 130, e.g. from communication device 110 and/or merchant device 160, one or more digital wallets and/or payment accounts belonging to user 102 and/or the merchant may be found. Database 136 may also store the user preferences for user 102, as well as information used to determine the user preferences. Benefits for use of payment instruments may also be stored to database 136, as well as user information to determine a prospective merchant that user 102 may visit/transact with.

In various embodiments, payment provider server 130 includes at least one network interface component 148 adapted to communicate communication device 110, secondary device 120, and/or merchant device 160 over network 170. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Merchant device 160 may be maintained, for example, by a merchant providing one or more items (e.g., products, goods, services, etc.) for sale to user 102. In this regard, merchant device 160 includes one or more processing applications which may be configured to interact with communication device 110, secondary device 120, and/or payment provider server 130 to engage in a transaction for sale of the item(s) selected by user 102. In one example, merchant device 160 may be provided by EBAY®, Inc. of San Jose, Calif., USA or STUBHUB®, Inc. of San Francisco, Calif., USA. However, in other embodiments, merchant device 160 may be maintained by or include other types of merchants, including real-world physical merchants at physical merchant locations (e.g., brick and mortar stores). Although a merchant device is shown, the merchant device may be managed or controlled by any suitable processing device. Although only one merchant device is shown, a plurality of merchant devices may function similarly.

Merchant device 160 of FIG. 1 contains a sales module 162, other applications 164, a database 166, and a communication module 168. Sales module 162 and other applications 164 may correspond to processes, procedures, and/or applications executable by a hardware processor, for example, a software program. In other embodiments, merchant device 160 may include additional or different modules having specialized hardware and/or software as required.

Sales module 162 may correspond to one or more processes to execute modules and associated specialized hardware of merchant device 160 that provide checkout and payment processes for a transaction to purchase one or more items for sale from the merchant corresponding to merchant device 160. In this regard, sales module 162 may correspond to specialized hardware and/or software of merchant device 160 to provide a convenient interface to permit a merchant to enter, view, and/or edit items and/or services for purchase by user 102. For example, sales module 162 may be implemented as an application having a user interface enabling the merchant to enter item information and request payment for a transaction on checkout/payment of one or more items/services. In certain embodiments, sales module 162 may correspond more generally to a web browser configured to view information available over the Internet or access a website corresponding to the merchant and/or payment provider server 140. Thus, sales module 160 may provide item sales through an online marketplace using the website of the merchant.

Once a payment amount is determined for a transaction for items to be purchased by user 102, sales module 162 may request payment from user 102. Secondary device 120 may be utilized to interact with sales module 162 in order to provide a payment mechanism for user 102's selected payment instrument and complete payment using the payment instrument, as discussed herein. The mechanism may correspond to a displayable code, digital credential, digital token, and/or required information determined by communication device 110 and/or payment provider server 160 for the payment instrument. Thus, the information in the mechanism may be used to authenticate user 102 and allow for payment. Sales module 162 may receive the mechanism from a scan of a displayed code by secondary device 120, entry of input of information from secondary device 120, and/or receipt of a short range wireless communication from secondary device 120. Thus, sales module 162 may be used to scan the information, input the information using an input device, image the information with a camera or video recorder, detect the location, record an audio recording with a microphone, capture a biometric using a sensor, or otherwise input the information. The provided mechanism may be communicated to payment provider server 150 with the transaction and transaction information by sales module 162 for approval. As discussed herein, payment provider server 150 may perform matching on the provided mechanism and determine whether to approve or decline the transaction. Sales module 162 may then receive the results of the transaction processing, and complete the transaction with user 102, for example, by providing the user the items for the transaction or declining the transaction where user 102 is not authenticated or the transaction is not authorized (e.g., insufficient funds).

Merchant device 160 includes other applications 164 as may be desired in particular embodiments to provide features to merchant device 160. For example, other applications 164 may include security applications for implementing client-side security features, programmatic client applications for interfacing with appropriate application programming interfaces (APIs) over network 170, or other types of applications. Other applications 164 may also include email, texting, voice and IM applications that allow a user to send and receive emails, calls, texts, and other notifications through network 170. In various embodiments, other applications 164 may include financial applications, such as banking, online payments, money transfer, or other applications associated with payment provider server 130. Other applications 134 may contain software programs, executable by a processor, including a graphical user interface (GUI) configured to provide an interface to the user.

Merchant device 160 may further include database 166 which may include, for example, identifiers such as operating system registry entries, cookies associated with sales module 162 and/or other applications 164, identifiers associated with hardware of merchant device 160, or other appropriate identifiers, such as identifiers used for payment/user/device authentication or identification. Database 166 may further include transaction information for a transaction between user 102 and the merchant corresponding to merchant device 160. Additionally, a mechanism used to receive payment may be stored to database 166, as well as received transaction results.

Merchant device 160 includes at least one communication module 168 adapted to communicate with communication device 110 and/or payment provider server 130. In various embodiments, communication module 168 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

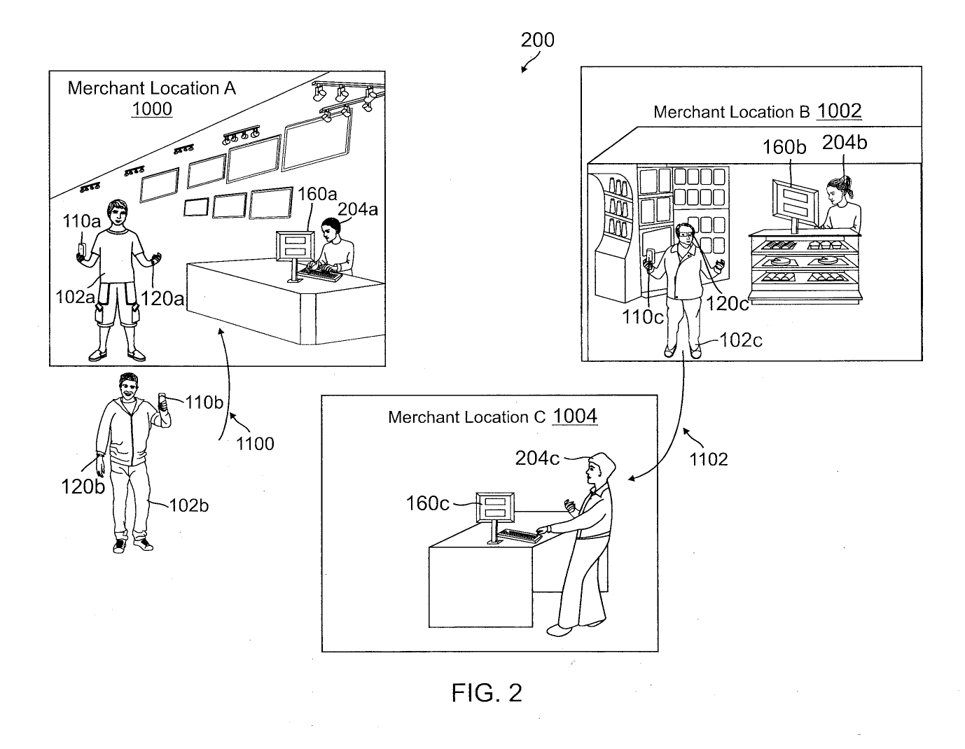

FIG. 2 is an exemplary environment where users may receive payment mechanisms to utilize funding sources through a secondary device for preferred rewards benefits, according to an embodiment. Environment 200 includes a user 102a utilizing a communication device 110a and a secondary device 120a, a user 102b utilizing a communication device 110b and a secondary device 120b, and a user 102c utilizing a communication device 110c and a secondary device 120c all corresponding generally to user 102 utilizing communication device 110 and wearable device 120, respectively, in environment 100 of FIG. 1. Moreover, environment 200 further includes a merchant device 160a, a merchant device 160b, and a merchant device 160c corresponding generally to merchant device 160 in environment 100 of FIG. 1.

User 102a may visit a merchant location A 1000 in order to purchase one or more items or otherwise engage in a transaction with a merchant 204a at merchant location A 1000. As shown in environment 200, user 102a is located within merchant location A 1000. Communication device 110a and/or secondary device 120a may detect the location of user 102a, for example, through a GPS transceiver. The location of user 102a may be provided to a service provider (e.g., payment provider server 130 in environment 100 of FIG. 1), which may determine that user 102a is located at merchant location A 1000. The service provider may further determine what payment instruments merchant 204a allows users, and/or user 102a specifically, to pay for items at merchant location A 1000. For example, merchant 204a may allow credit cards, debit cards, and/or cash at merchant location A 1000. In contrast, a merchant 20b at a merchant location B 1002 may allow more, less, or different payment instruments, including gift cards, coupons, bank account transfers, checks, etc. Similarly, a merchant 204c at a merchant location C 1004 may also allow specific payment instruments, which may be the same, similar, or different from merchant 204a and merchant 204b.

Once the payment instruments accepted by merchant 204a are determined, the service provider may further access a digital wallet for user 102a (i.e., including payment instruments that accrue benefits and other rewards from use in transactions) and determine user preferences for receipt of benefits from use of the payment instruments available to user 102a in the digital wallet. Once the user preferences are accessed/determined, the service provider may make a selection of one or more of the payment instruments to utilize in a transaction between user 102a and merchant 204a. The transaction may be a potential or prospective transaction prior to user 102a's selection of a payment instrument. However, in other embodiments, user 102a and/or merchant 204a may generate a transaction and communicate the transaction information to the service provider for determination of the payment instrument. The payment instrument may be selected based on which payment instrument(s) provide the benefit that user 102a prefers to receive. The benefit may be the most highly prioritized by user 102a, and where multiple payment instruments provide the same benefit, the service provider may further select the payment instrument based on user 102a's preference for which payment instrument to user, goals for benefits earnings, financial aspects of the payment instrument (e.g., APR, available funds, etc.), or other setting.

The service provider may then determine a payment mechanism that allows user 102a to provide payment to merchant 204a for a transaction using the selected payment instrument. For example, the mechanism may correspond to a scan-able code, a digital token, and/or other information. The mechanism may be communicated to communication device 110a, which may provide the mechanism to secondary device 120a (e.g., through short range wireless communications), or may be transmitted to secondary device 120a over a network connection with secondary device 120a. Secondary device 120a may then be used to provide the mechanism to merchant 204a through merchant device 160a, which may resolve the mechanism with the service provider and receive payment for the transaction.

In environment 200, user 102b is shown outside of merchant location A 1000. User 102b may further have established a digital wallet with the service provider with payment instruments, and provided input in order for the service provider to determine user preferences for use of payment instruments in order to receive benefits from the use of the payment instruments. The service provider may receive user information for user 102b that indicates that user 102b may travel a route 1100 to merchant location A 1000. For example, user 102b may have entered route 1000 to communication device 110b. In other embodiments, communication device 110b may detect a location for user 102b and determine that user 102b often takes route 1100 to merchant location A 1000. Thus, prior to user 102b arriving at merchant location A 1000 after travelling route 1100, the service provider may select a payment instrument for user 102b to use in a transaction with merchant 204a at merchant location A 1000. The service provider may then determine a mechanism to allow user 102b to use the payment instrument with merchant 204a at merchant location A 1000 using secondary device 110b. The mechanism may be directly communicated to secondary device 120b, or may be communicated to secondary device 120b through communication device 110b.

User 102c may also receive a mechanism for a payment instrument selected from user 102c's digital wallet for use at a merchant location B 1002 with merchant 204b. User 102c may utilize secondary device 120c to provide the mechanism to merchant 204b through merchant device 160b. However, as shown in environment 200, user 102c may travel a route 1102 to a merchant location C 1004. The mechanism for the payment instrument used at merchant location B 1002 may be limited to merchant location B 1002 and/or merchant 204b. Thus, once user 102c is detected as travelling route 1102 and/or at merchant location C 1004 (e.g., using communication device 110c), the payment mechanism may be deactivated. In other embodiments, the payment mechanism may be ineffective or barred from use with merchant 204c. For example, merchant device 160c may not accept the mechanism and/or the transaction may be declined with merchant device 160c. Moreover, the service provider may determine another payment instrument for user 102c to use with merchant 204c at merchant location C 1004, and may determine a further mechanism for the other payment instrument for use through secondary device 120c.

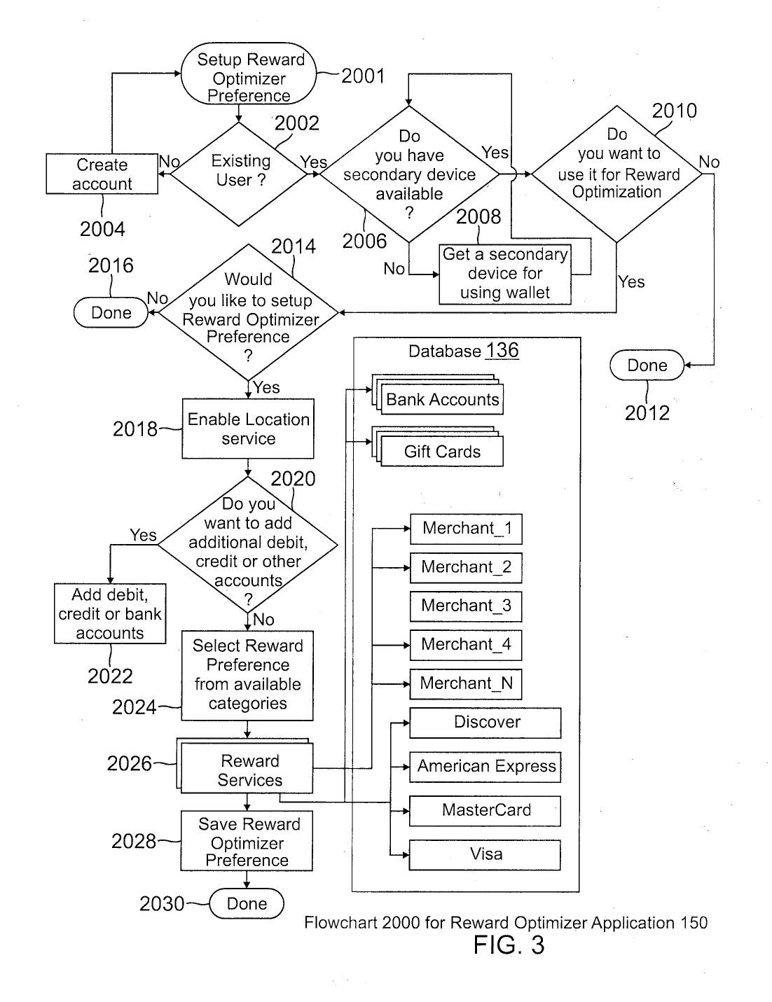

FIG. 3 is an exemplary interaction flowchart and resulting digital wallet having user preferences during establishment of the digital wallet and user preferences for rewards optimization, according to an embodiment. FIG. 3 includes reward optimizer application 150, which may be executed by payment provider server 130 in environment 100 of FIG. 1. Moreover, FIG. 3 includes database 136 from payment provider server 130 in environment 100 of FIG. 1.

Thus, a payment provider server executes reward optimizer application 150 corresponding generally to the specialized hardware and/or software modules and processes described in reference to FIG. 1. In this regard, a flowchart 2000 for reward optimizer application 150 is shown in FIG. 3. Flowchart 2000 displays an exemplary process to establish a digital wallet and set user preferences for use of payment instruments in the digital wallet based on benefits earned through use of the payment instruments. At box 2001, reward optimization is initiated for setup to determine payment instruments based on the user's information and user preferences for benefits earnings. It is determined whether the user is an existing user, at box 2002. If the user is not an existing user, at box 2004, an account is created. However, if the user is an existing user, at box 2006, a secondary device is requested. The user may identify the secondary device using an identifier for the secondary device, or other information, such as device capabilities, device name/brand/version/etc., or other information. If the user does not have a secondary device, reward optimizer application 150 may request the user to obtain a secondary device, at box 2008. Once the user has a secondary device, the user may utilize the secondary device for reward optimization, at box 2010, for example, by providing the required information for identification of the secondary device. However, if the user chooses not to use the secondary device for reward optimization, then at box 2012, reward optimizer application 150 ends the process of flowchart 2000.

However, if the user selects to use the secondary device for reward optimization, at box 2014, reward optimizer application 150 inquires as to whether the user would like to establish reward optimizer preferences. If the user does not wish to set preferences, reward optimizer application 150 may end the process of flowchart 2000, at box 2016. In such embodiments, reward optimizer application 150 may set general or default user preferences for reward optimization, or may not enroll the user in reward optimization. Where default user preferences are set, the default user preferences may be based on a default benefits earnings plan, or may be based on crowd-sourced information. However, if the chooses to enroll in reward optimization, at box 2018, reward optimizer application 150 may request that the user enable location services, as well as other user data gathering processes to determine one or more merchants visited or to visit by the user. Once location services are enabled, the user may be request to add additional payment instruments and other funding sources, to the digital wallet for benefits earnings, such as debit cards, credit card, and other accounts, at box 2020. If the user wishes to add additional cards, reward optimizer application 150 may allow addition of the payment instruments, at box 2022. Once satisfied, at box 2024, the user is requested to select from available categories and/or otherwise input information that allow reward optimizer application 150 to determine the user's preferences for use of the payment instruments in the digital wallet according to benefits earnings that the user wishes to receive. For example, at box 2026, reward services may be determined for information available in database 136. The information available in database 136 may include bank accounts for the user and gift cards for the user, as well as various payment cards, such as DISCOVER® cards, AMERICAN EXPRESS® cards, MASTERCARD® cards, and/or VISA® cards. Each of the funding sources may include benefit earning information, which may be used to select benefit preferences and/or determine a payment instrument at a merchant location.

Additionally, the information in database 136 may include merchants, such as merchants 1-N, which may be used to determine available payment instruments at a merchant location, select a payment instrument based on the payment instrument's benefits earned through use of the payment instrument and the merchant location, and access any rewards programs that the user has available at the merchant location. Once the information is accessed, at box 2026, the user preferences may be determined. At box 2028, the reward optimizer user preferences for use of payment instruments based on benefits the user prioritizes for earning are determined and stored to database 136. Thus, at box 2030, reward optimizer application 150 is done and completes. The user preferences may then later be used for payment instrument selection, as described herein.

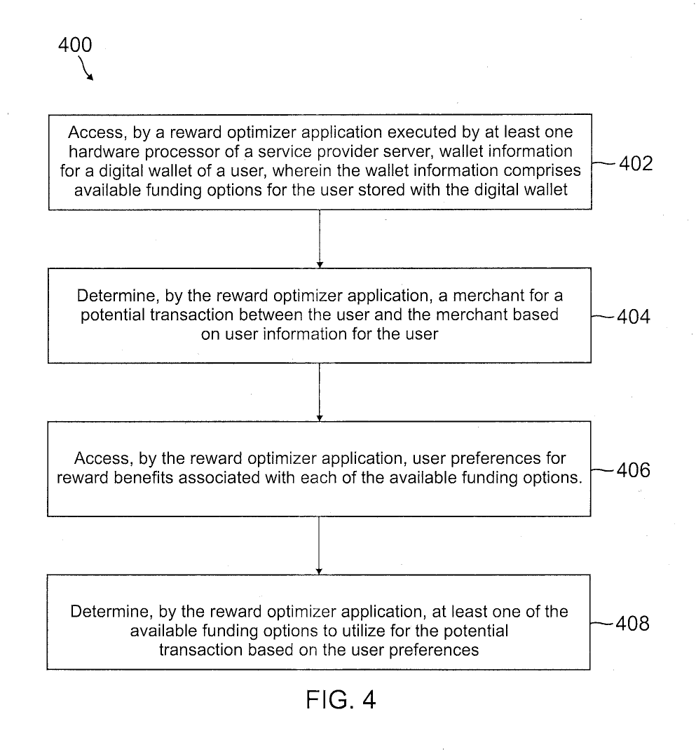

FIG. 4 is a flowchart of an exemplary process for secondary device communications to provide an electronic payment instrument to maximize benefits, according to an embodiment. Note that one or more steps, processes, and methods described herein may be omitted, performed in a different sequence, or combined as desired or appropriate.

At step 402, a reward optimizer application executed by at least one hardware processor of a service provider server accesses wallet information for a digital wallet of a user, wherein the wallet information comprises available funding options for the user stored with the digital wallet. The payment instruments may comprise at least one of credit cards, debit cards, bank accounts, funds in a brokerage account, electronic payment accounts, merchant credit accounts, gift cards, coupon codes, discount codes, rewards accounts, and available cash-back from at least one rewards account. The reward optimizer application determines a merchant for a potential transaction between the user and the merchant based on user information for the user, at step 404. The user information may comprise at least one of a location of the user, a travel route traveled by the user, a check-in at a merchant location, a transaction history, a travel distance in a vehicle, the vehicle used by the merchant, at least one biometric of the user, and an associated user travelling with the user. The user information may be received from one of a communication device of the user and the secondary device prior to the determining the merchant for the potential transaction

At step 406, the reward optimizer application access user preferences for benefits associated with each of the available funding options. The benefits may comprise at least one of rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons. The user preferences for the benefits may comprise a ranking of each of the benefits, and wherein the ranking determines the at least one funding option to utilize based on a received benefit from the use of the at least one funding option for the transaction to priority the each of the benefits based on the ranking. In other embodiments, the user preferences are associated with types of the benefits received from use of the funding options, wherein the types of the benefit comprises at least one of a cash-back reward, a percentage savings reward, points for use in a rewards program, and airlines miles achieved through use of at least one of the funding options, at least one benefit for a specific merchant, coupons for the specific merchant, membership benefits in the reward program, and membership level increases in the rewards program.

The reward optimizer application determines at least one of the available funding options to utilize for the potential transaction based on the user preferences, at step 408. In various embodiments, a payment processing mechanism for use the at least one of the available funding options may be communicated to a secondary device for the user, wherein the secondary device further communicates the payment instrument to a merchant device for the merchant to process a transaction between the user and the merchant. In certain embodiments, a cash-back benefit for at least one of the rewards benefits may be received from use of the at least one funding options, and the cash-back benefit may be provided to a brokerage company for use in an investment brokerage account. For example, the user may request that the cash-back be placed in a financial investment account that the user owns/controls/uses.

A transaction processing application executed by the at least one processor of the service provider server may process a transaction between the user and the merchant using the at least one funding option received from at least one of a merchant device for the merchant and the secondary device, wherein the merchant device initiates the transaction after receiving the at least one funding option from the secondary device. The user may initiate the transaction with the merchant by utilizing the secondary device to communicate at least one payment mechanism for the at least one funding option to the merchant device. A wallet provider application executed by the at least one processor of the service provider server may determine the at least one payment mechanism for the at least one funding option based on device capabilities of the secondary device, wherein the secondary device comprises a wearable computing device.

The wallet provider application executed by the at least one processor of the service provider server may also receive the payment instruments for the user and establish the digital wallet for the user using the payment instruments. The reward optimizer application may further receive selection of use preferences for each of the payment instruments for transactions based on the benefits during establishment of the digital wallet and establish the user preferences with the digital wallet. The reward optimizer application may further receive an identifier for the secondary device, wherein the reward optimizer may also store the identifier with the digital wallet for use of the at least one funding option through the secondary device during the transaction.

The user may further allow location detection services available using at least one of the communication device and the secondary device with the reward optimizer application, wherein the reward optimizer application determines the user information using the location detection services. The reward optimizer application may further receive an order of use of each of the payment instruments for transactions based on each of the benefits associated with the each of the payment instruments and determine the user preferences using the order of use of the each of the payment instruments. The reward optimizer application may further receive a first goal of an amount to achieve for at least one of the benefits and determines the user preferences using the first goal. In this regard, the reward optimizer application may also receive at least one second goal to achieve after completing the first goal and determine the user preferences using the at least one second goal.

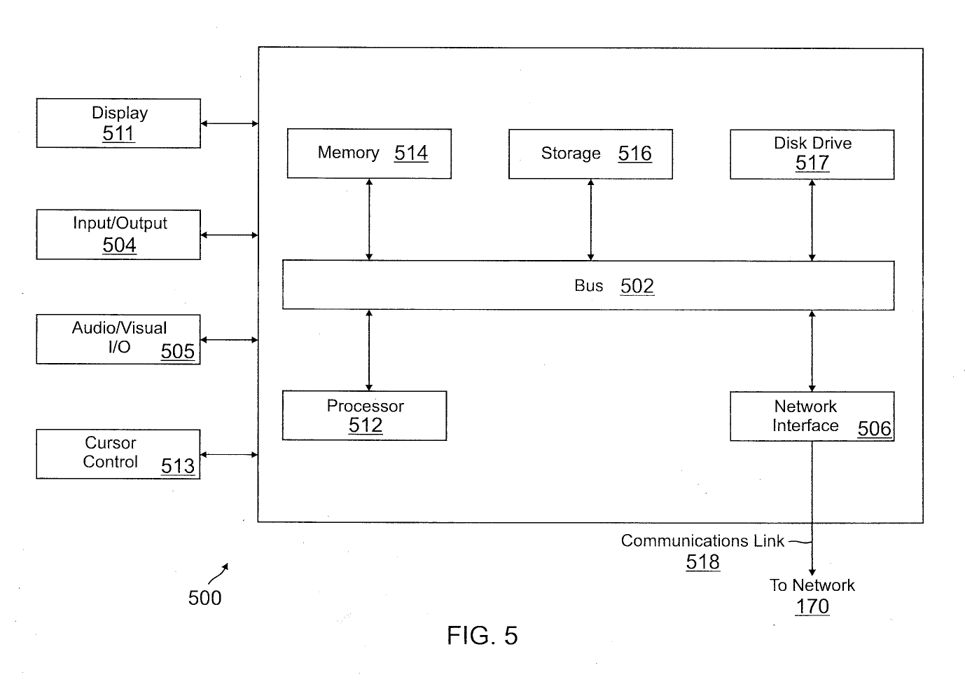

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a reward optimizer application executed by at least one hardware processor of a service provider server that accesses a digital wallet of a user, wherein the digital wallet comprises payment instruments for the user stored with the digital wallet, accesses user information for a user, determines a merchant associated with the user based on the user information, wherein the user is associated with the merchant to engage in a transaction between the user and the merchant, accesses user preferences for benefits received by use each of the payment instruments, determines at least one of the payment instruments to utilize for the transaction based on the user preferences; and determines a mechanism for use of the at least one of the payment instruments through a secondary device of the user;
a database stored to a non-transitory memory that stores the digital wallet, the user information, the user preferences, and the at least one of the payment instruments; and
a network interface component that receives the user information and communicates the mechanism for use of at least one of the payment instruments to at least one of a communication device for the user and a secondary device for the user, wherein the at least one funding option is used in the transaction between the user and the merchant.

2. The system of claim 1, wherein the payment instruments comprise at least one of credit cards, debit cards, bank accounts, funds in a brokerage account, electronic payment accounts, merchant credit accounts, gift cards, coupon codes, discount codes, rewards accounts, and available cash-back from at least one rewards account.

3. The system of claim 1, wherein the benefits comprise at least one of rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons.

4. The system of claim 3, wherein the user preferences for the benefits comprise a ranking of each of the benefits, and wherein the ranking determines the at least one funding option to utilize based on a received benefit from the use of the at least one funding option for the transaction to priority the each of the benefits based on the ranking.

5. The system of claim 1, wherein the user information comprises at least one of a location of the user, a travel route traveled by the user, a check-in at a merchant location, a transaction history, a travel distance in a vehicle, the vehicle used by the merchant, at least one biometric of the user, and an associated user travelling with the user.

6. The system of claim 1, further comprising:
a transaction processing application executed by the at least one processor of the service provider server that processes the transaction using the at least one of the payment instruments, and wherein the merchant device initiates the transaction after receiving the mechanism for use of the at least one of the payment instruments from the secondary device.

7. The system of claim 6, wherein the user initiates the transaction with the merchant by utilizing the secondary device to communicate the mechanism to the merchant device.

8. The system of claim 7, further comprising:
a wallet provider application executed by the at least one processor of the service provider server that determines the mechanism based on device capabilities of the secondary device, and wherein the secondary device comprises a wearable computing device.

9. The system of claim 1, further comprising:
a wallet provider application executed by the at least one processor of the service provider server that receives the payment instruments for the user and establishes the digital wallet for the user using the payment instruments,
wherein the reward optimizer application further receives selection of use preferences for each of the payment instruments for transactions based on the benefits during establishment of the digital wallet and establishes the user preferences with the digital wallet.

10. The system of claim 9, wherein the reward optimizer application further receives an identifier for the secondary device, and wherein the reward optimizer stores the identifier with the digital wallet for use of the at least one funding option through the secondary device during the transaction.

11. The system of claim 9, wherein the user further allows location detection services available using at least one of the communication device and the secondary device with the reward optimizer application, and wherein the reward optimizer application determines the user information using the location detection services.

12. The system of claim 9, wherein the reward optimizer application further receives an order of use of each of the payment instruments for transactions based on each of the benefits associated with the each of the payment instruments and determines the user preferences using the order of use of the each of the payment instruments.

13. The system of claim 9, wherein the reward optimizer application further receives a first goal of an amount to achieve for at least one of the benefits and determines the user preferences using the first goal.

14. The system of claim 13, wherein the reward optimizer application further receives at least one second goal to achieve after completing the first goal and determines the user preferences using the at least one second goal.

15. A method comprising:
accessing, by a reward optimizer application executed by at least one hardware processor of a service provider server, wallet information for a digital wallet of a user, wherein the wallet information comprises available funding options for the user stored with the digital wallet;
determining, by the reward optimizer application, a merchant for a potential transaction between the user and the merchant based on user information for the user;
accessing, by the reward optimizer application, user preferences for benefits associated with each of the available funding options;
determining, by the reward optimizer application, at least one of the available funding options to utilize for the potential transaction based on the user preferences; and
determining, by the reward optimizer application, a payment processing mechanism for use of the at least one of the available funding options through a secondary device of the user.

16. The method of claim 15, further comprising:
communicating the payment processing mechanism for use the at least one of the available funding options to a secondary device for the user, wherein the secondary device further communicates the payment processing mechanism to a merchant device for the merchant to process a transaction between the user and the merchant.

17. The method of claim 16, further comprising:
receiving the user information from one of a communication device of the user and the secondary device prior to the determining the merchant for the potential transaction.

18. The method of claim 15, wherein the user preferences are associated with types of the benefits received from use of the funding options, and wherein the types of the benefit comprises at least one of a cash-back reward, a percentage savings reward, points for use in a rewards program, and airlines miles achieved through use of at least one of the funding options, at least one benefit for a specific merchant, coupons for the specific merchant, membership benefits in the reward program, and membership level increases in the rewards program.

19. The method of claim 15, further comprising:
receiving a cash-back benefit for at least one of the rewards benefits from use of the at least one funding options; and
providing the cash-back benefit to a brokerage company for use in an investment brokerage account.

20. A non-transitory computer-readable medium comprising executable modules which, in response to execution by a computer system, cause the computer system to perform a method comprising:
accessing, by a reward optimizer application executed by at least one hardware processor of a service provider server, wallet information for a digital wallet of a user, wherein the wallet information comprises available funding options for the user stored with the digital wallet;
determining, by the reward optimizer application, a merchant for a potential transaction between the user and the merchant based on user information for the user;
accessing, by the reward optimizer application, user preferences for benefits associated with each of the available funding options;
determining, by the reward optimizer application, at least one of the available funding options to utilize for the potential transaction based on the user preferences; and
determining, by the reward optimizer application, a payment processing mechanism for use of the at least one of the available funding options through a secondary device of the user.
